(19) United States
(12) Patent Application Publication
(10) Pub. No.: US 2004/0221818 A1
(43) Pub. Date: Nov. 11, 2004

(54) Device for aiding an infant engaged in a physical activity

(76) Inventors: Ines Rother, Mountain View, CA (US); Hillary M. Chierici, San Carlos, CA (US)

Correspondence Address: Henry C. Query, Jr., 504 S. Pierce Avenue, Wheaton, IL, 60187, US

(21) Appl. No.: 10/431,176

(22) Filed: May 6, 2003

(51) Int. Cl. B60R 22/12; A62B 35/00

(52) U.S. Cl. 119/770

(57) ABSTRACT

A device for aiding an infant engaged in a physical activity comprises a harness which includes a front support and a mechanism for securing the front support to the infant's torso, and at least first and second elongated straps, each of which comprises a proximal end that is connected to or formed integrally with a corresponding side of the harness and a distal end that is adapted to be held by a person. The first and second straps each comprise a length which is sufficient to allow the person to support the infant in a position which is required by the physical activity while the person remains in a desired position. Thus, the person can support the infant from the desired position while the infant is engaged in the physical activity.

### BACKGROUND OF THE INVENTION

The present invention relates to a device for aiding an infant engaged in a physical activity. More particularly, the invention relates to such a device which comprises a harness that is secured around the infant's torso and a pair of preferably adjustable straps which are connected to the harness and which will allow a person to support the infant as the infant is engaged in a physical activity, such as learning to walk.

Generally, when infants are first learning to walk, they lack balance and stability. Parents, guardians or other such persons often attempt to help the infant in this endeavor by holding the infant's hands to support the infant in a standing position. However, since most persons are substantially taller than infants, they are required to bend or stoop in order to hold the infant's hands. Such a position is often found to be uncomfortable and can sometimes lead to back problems.

### SUMMARY OF THE INVENTION

In accordance with the present invention, these and other disadvantages are overcome by providing a device for aiding an infant engaged in a physical activity, such as learning to walk. The device comprises a harness which includes a front support and means for securing the front support to the infant's torso, and at least first and second elongated straps, each of which comprises a proximal end that is connected to or formed integrally with a corresponding side of the harness and a distal end that is adapted to be held by a person. Furthermore, the first and second straps each comprise a length which is sufficient to allow the person to support the infant in a position which is required by the physical activity while the person remains in a desired position.

Thus, the present invention allows the person to support the infant from a comfortable position while the infant is engaged in the physical activity. In addition, the straps are preferably adjustable to enable the use of the invention by persons of different heights.

These and other objects and advantages of the present invention will be made apparent from the following detailed description, with reference to the accompanying drawings.

### BRIEF DESCRIPTION OF THE DRAWINGS

FIG. 1 is a rear perspective view of the device of the present invention;

FIG. 2 is a front perspective view of the device of FIG. 1 shown secured to an infant; and

FIG. 3 is a rear perspective view of the device of FIG. 1 shown secured to an infant.

### DETAILED DESCRIPTION OF THE PREFERRED EMBODIMENTS

The present invention is designed to enable a person to provide support to an infant engaged in a physical activity. In particular, the invention allows a person to securely support the infant in a position required by the physical activity while the person remains in a desired position. Moreover, the invention may be used to aid the infant in a variety of physical activities, such as walking, skiing and swimming. In this regard, the infant may be required to be in a standing position while walking or skiing or a prone position while swimming. At the same time, the person may prefer to support the infant in these activities from a comfortable upright position.

Thus, the present invention has wide application to many physical activities requiring different positions, both of the infant and the person providing support to the infant. However, for purposes of simplicity the invention will be described in the context of a device which allows a person to support the infant in a standing position as the infant attempts to walk.

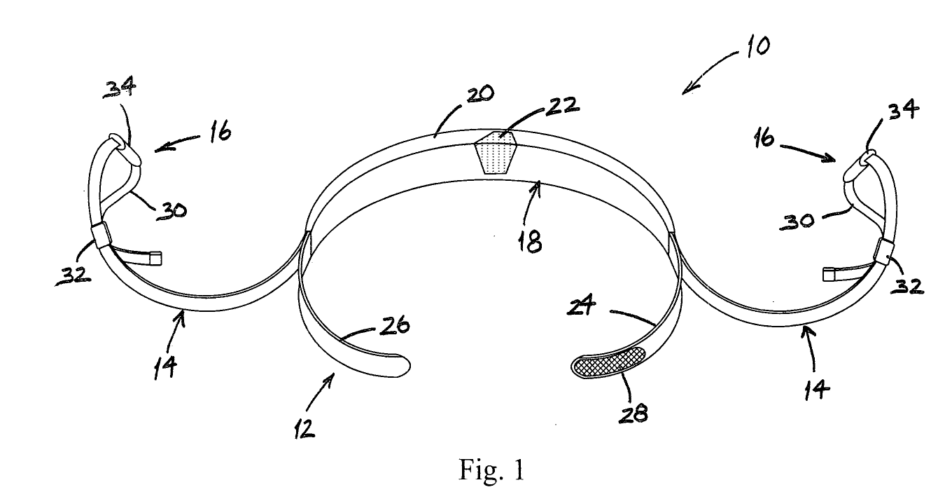

Referring to FIG. 1, the device of the present invention, which is indicated generally by reference number 10, is shown to comprise a harness 12 which is adapted to be secured around an infant's torso, preferably two straps 14, each of which is connected to or formed integrally with a corresponding side of the harness, and two handles 16, each of which is connected to or formed integrally with the distal end of a corresponding strap. In use, the harness 12 is secured to the infant's torso, ideally under the infant's arm pits, and by holding the handles 16 a person can support the infant as the infant stands and attempts to walk.

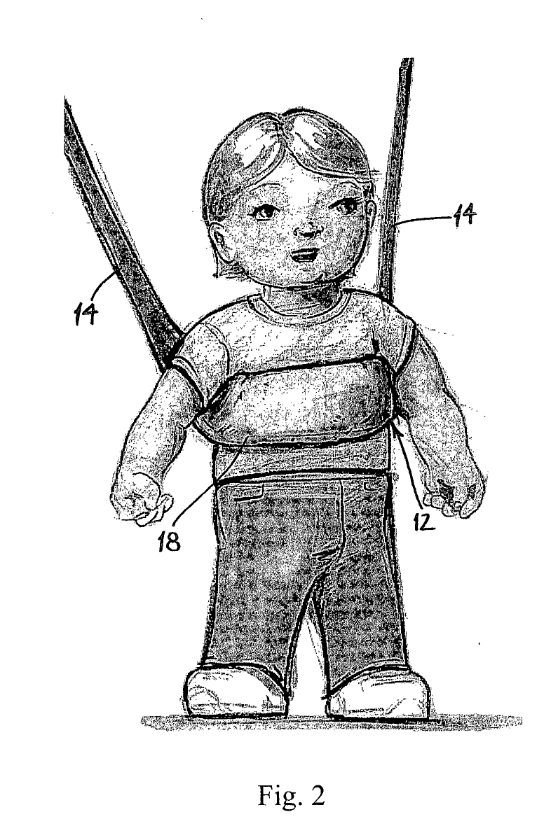

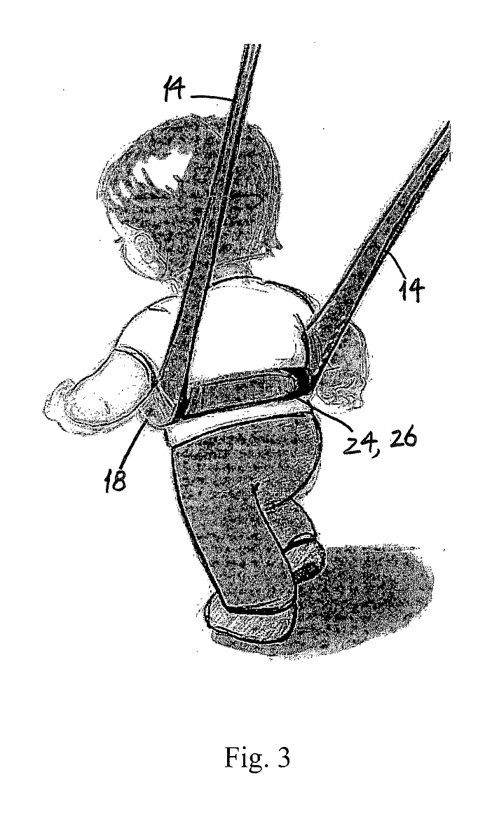

According to an illustrative embodiment of the invention, the harness 12 comprises a front support 18 and means for securing the front support to the infant's torso. The front support 18 is a flexible, elongated member which as shown in FIGS. 2 and 3 is adapted to extend around the infant's chest and under the infant's arms. The front support 18 is constructed of a material which is sufficiently strong to support the weight of the infant without unduly stretching or tearing. In addition, the front support is preferably sufficiently soft and resilient to protect the infant's torso from the strain imparted by the harness 12. In one embodiment of the invention, for example, the front support 18 comprises an elongated, generally tubular cover 20 which is constructed of a relatively strong material, and a suitable filling, padding or other such cushion 22 which is enclosed within the cover. According to this embodiment, the cover 20 is attached to the handles 14 and therefore bears the weight of the infant, and the cushion 22 mitigates the strain which the cover imparts on the infant's torso. In an exemplary embodiment of the invention, the cover 20 is constructed of a durable, preferably washable cotton, and the cushion 22 comprises a foam rubber insert.

Referring still to FIG. 1, the means for securing the front support 18 to the infant's torso is shown to comprise at least first and second elongated flaps 24 and 26, each of which is connected to or formed integrally with the front support. As shown in FIG. 3, the flaps 24, 26 are designed to be secured across the infant's back to thereby maintain the front support 18 in position around the infant's chest and under the infant's arms. Accordingly, the securing means also includes means for attaching the first flap 24 to the second flap 26. In a preferred embodiment of the invention, this attaching means is adjustable to accommodate infants of varying size. In the illustrative embodiment of the invention shown in FIG. 1, for example, the attaching means comprises a portion of Velcro®-like material 28 which is affixed to the first flap 24 and which is adapted to releasably engage a corresponding portion of Velcro®-like material (not visible in FIG. 1) that is affixed to the second flap 26.

Any other suitable means may be employed to adjustably attach the first flap 24 to the second flap 26, including one or more pairs of cooperating snaps, buckles or buttons. Alternatively, the first and second flaps 24, 26 may simply be tied together with a suitable bow or knot.

Although the first and second flaps 24, 26 are shown in FIG. 1 to be separate members, they may in fact comprise the opposite ends of a single belt or strip of material which is connected to or formed integrally with the front support 18. For example, the flaps 24, 26 could be the opposite ends of a belt which is attached such as by stitching to the cover 20 of the front support 18. Alternatively, the flaps 24, 26 could comprise the elongated ends of the cover 20, which in this example would be sufficiently long to extend completely around the infant's torso. Other embodiments of the flaps 24, 26 may be readily derived by the person of ordinary skill in the art from the above examples and should therefore be considered to be included within the scope of the present invention.

As shown in FIG. 1, each strap 14 comprises an elongated strip of material which includes a proximal end that is connected to the front support 18 and a distal end to which a corresponding handle 16 is connected. The straps 14 are constructed of a material which is sufficiently strong to support the weight of the infant without breaking or unduly stretching. For example, the straps 14 may be constructed of a vinyl webbing-like material.

Furthermore, although the straps 14 are shown in FIG. 1 to be separate members, each strap may alternatively comprise a corresponding end of a single elongated strip of material which is connected to or formed integrally with the front support 18. For example, the straps 14 could be the opposite ends of a strip of material which is attached such as by stitching to the cover 20 of the front support 18. Alternatively, the straps 14 could comprise the elongated ends of the cover 20, which in this example would be sufficiently long to allow a person to comfortably support an infant from an upright position. Other embodiments of the straps 14 may be readily derived by the person of ordinary skill in the art from the above examples and should therefore be considered to be included within the scope of the present invention.

Referring still to FIG. 1, each handle 16 ideally comprises a loop 30 which is connected to or formed integrally with the distal end of its corresponding strap 14. In a preferred embodiment of the invention, the loop 30 is formed by folding over the distal end of the strap 14 and securing it to an adjacent portion of the strap. Each handle 16 therefore preferably also includes suitable means for securing the distal end of the strap 14 to its adjacent portion. In a preferred embodiment of the invention, this securing means is adjustable to alter the length of the strap 14 between the loop 30 and the harness 12 so that the device 10 may be used by persons and infants of varying heights. In the illustrative embodiment of the invention shown in FIG. 1, for example, the securing means comprises a buckle 32 which is mounted on the adjacent portion of the strap 14 and through which the distal end of the strap is threaded. As is well known to those of ordinary skill in the art, the buckle 30 may be selectively positioned on the strap 14 to thereby either lengthen or shorten the strap between the loop 30 and the harness 12. Although not required, each handle 16 preferably also includes a hand grip 34 which may comprise, for example, a cushioned tubular body through which the distal end of the strap 14 is threaded.

It should be understood that the handles 16 could comprise any desired construction and configuration. For example, any suitable means may be employed to secure the distal end of each strap 14 to its adjacent portion to form each loop 30. Alternatively, each handle 16 could simply comprise the distal end of its corresponding strap 14, or any other portion of the strap which a person may find convenient to hold while using the device 10.

In use of the device 10, the harness 12 is secured around the infant's torso by positioning the front support across the infant's chest and attaching the flaps 24, 26 together across the infant's back. A parent, caregiver or other such person may then assist the infant into a standing position by gently lifting up on the handles 16. As the infant attempts to walk, he will lean forward and a portion of his weight will be transferred through the front support 18 and the straps 16 to the person. The device 10 will therefore provide the necessary balance to allow the infant to remain in the standing position while leaning forward to walk. In addition, the straps 14 will allow the person to support the infant in this balanced standing position while remaining in a comfortable, upright position.

It should be recognized that, while the present invention has been described in relation to the preferred embodiments thereof, those skilled in the art may develop a wide variation of structural and operational details without departing from the principles of the invention. Therefore, the appended claims are to be construed to cover all equivalents falling within the true scope and spirit of the invention.

1. A device for aiding an infant engaged in a physical activity, the device comprising:
a harness which includes a front support and means for securing the front support to the infant's torso; and
an elongated strip of material which is connected to the front support and which comprises first and second ends that define corresponding first and second elongated straps, each of which comprises a distal end that is adapted to be held by a person;
wherein the first and second straps each comprise a length which is sufficient to allow the person to support the infant in a position which is required by the physical activity while the person remains in a desired position; and
whereby the person can support the infant from the desired position while the infant is engaged in the physical activity.

2. The device of claim 1, wherein the securing means comprises at least first and second flaps, each of which is connected to or formed integrally with a corresponding side of the front support.

3. The device of claim 2, wherein each of the first and second flaps comprises a corresponding end of a single belt which is connected to or formed integrally with the front support.

4. The device of claim 2, wherein the securing means further comprises means for adjustably attaching the first flap to the second flap.

5. The device of claim 4, wherein the attaching means comprises a portion of Velcro®-like material which is affixed to the first flap and which is adapted to releasably engage a corresponding portion of Velcro®-like material that is affixed to the second flap.

6. The device of claim 1, wherein the front support comprises an elongated cushion.

7. The device of claim 6, wherein the cushion comprises a foam rubber insert.

8. The device of claim 6, wherein the front support further comprises a cover which substantially encases the cushion.

9. (canceled).

10. The device of claim 8, wherein the strip of material comprises the cover.

11. (canceled).

12. (canceled).

13. (canceled).

14. The device of claim 1, further comprising first and second handles, each of which is connected to or formed integrally with the distal end of a corresponding strap.

15. The device of claim 14, wherein each handle comprises a loop which is connected to or formed integrally with the distal end of the strap.

16. The device of claim 15, further comprising means for securing the distal end of the strap to an adjacent portion of the strap to thereby form the loop.

17. The device of claim 16, wherein the securing means comprises a buckle which is mounted on the adjacent portion of the strap and through which the distal end of the strap is threaded.

18. The device of claim 17, wherein the buckle is movably mounted on the strap and wherein the length of the strap may be adjusted by selectively positioning the buckle on the strap.

19. A device for aiding an infant engaged in a physical activity, the device comprising:
a harness which includes a front support and means for securing the front support to the infant's torso;
at least first and second elongated straps, each of which comprises a proximal end that is attached to a corresponding side of the harness and a distal end that is adapted to be held by a person;
wherein the first and second straps each comprise a length which is sufficient to allow the person to support the infant in a position which is required by the physical activity while the person remains in a desired position;
first and second handles, each of which is connected to or formed integrally with the distal end of a corresponding strap;
wherein each handle comprises a loop which is connected to or formed integrally with the distal end of the strap; and
wherein each handle further comprises a hand grip which is connected to the handle.

20. The device of claim 19, wherein the hand grip comprises a generally tubular body through which the strap extends.

21. A device for aiding an infant engaged in a physical activity, the device comprising:
a harness which includes a front support and means for securing the front support to the infant's torso; and
at least first and second elongated straps, each of which comprises a proximal end that is attached to a corresponding side of the harness and a distal end that is adapted to be held by a person;
wherein the first and second straps each comprise a length which is sufficient to allow the person to support the infant in a position which is required by the physical activity while the person remains in a desired position; and
wherein each strap comprises a corresponding end of a single elongated strip.

22. The device of claim 21, wherein the strip is connected to the front support.

23. The device of claim 21, wherein the strip is formed integrally with the front support.

24. The device of claim 21, wherein the front support comprises an elongated cushion.

25. The device of claim 24, wherein the front support further comprises a cover which substantially encases the cushion.

26. The device of claim 25, wherein the cover comprises the strip and each strap comprises a corresponding end of the cover.

27. A device for aiding an infant engaged in a physical activity, the device comprising:
a harness which includes a front support and means for securing the front support to the infant's torso; and
at least first and second elongated straps, each of which comprises a proximal end that is attached to a corresponding side of the harness and a distal end that is adapted to be held by a person;
wherein the first and second straps each comprise a length which is sufficient to allow the person to support the infant in a position which is required by the physical activity while the person remains in a desired position; and
wherein the front support comprises an elongated cushion and a cover which substantially encases the cushion.

28. The device of claim 27, wherein each strap is attached to the cover.

29. The device of claim 27, wherein each strap comprises a corresponding end of the cover.
